(19) United States
(12) Patent Application Publication
(10) Pub. No.: US 2020/0383128 A1
(43) Pub. Date: Dec. 3, 2020

(54) Short-Term Wi-Fi Blanking for Coexistence

(71) Applicant: Apple Inc., Cupertino, CA (US)

(72) Inventor: Oren Shani, Saratoga, CA (US)

(21) Appl. No.: 16/512,824

(22) Filed: Jul. 16, 2019

Related U.S. Application Data
(60) Provisional application No. 62/855,555, filed on May 31, 2019.

(51) Int. Cl. H04W 72/12; H04W 16/14; H04W 48/06; H04W 88/06

(52) U.S. Cl. CPC H04W 72/1215; H04W 16/14; H04W 76/15; H04W 72/1242; H04W 88/06; H04W 48/06

(57) ABSTRACT

Methods and apparatuses are presented to facilitate coexistence between multiple wireless communication protocols implemented by a wireless communication device, using a shared frequency range. A first protocol of the wireless communication protocols may be a comb protocol, characterized by a superframe signal format that includes communication periods separated by non-communication periods within the superframe. Specifically, the wireless communication device may communicate according to a second protocol during the non-communication periods of the superframe. The communication periods of the superframe may be sufficiently short to allow a radio implementing the second protocol may remain in an active state during the communication periods, e.g., without entering a sleep mode or notifying remote devices of any interruption of the second protocol.

### PRIORITY CLAIM

This application claims benefit of priority of U.S. provisional application Ser. No. 62/855,555, titled “Short-Term Wi-Fi Blanking for Coexistence”, filed May 31, 2019, whose inventor is Oren Shani, which is hereby incorporated by reference in its entirety as though fully and completely set forth herein.

### TECHNICAL FIELD

The present application relates to wireless communication, including to techniques for coexistence of multiple radio access technologies within a shared frequency range for wireless communication.

### DESCRIPTION OF THE RELATED ART

Wireless communication systems are rapidly growing in usage. Further, wireless communication technology has evolved from voice-only communications to also include the transmission of data, such as Internet and multimedia content.

Mobile electronic devices may take the form of smart phones or tablets that a user typically carries. Wearable devices (also referred to as accessory devices) are a newer form of mobile electronic device, one example being smart watches. Additionally, low-cost low-complexity wireless devices intended for stationary or nomadic deployment are also proliferating as part of the developing “Internet of Things”. In other words, there is an increasingly wide range of desired device complexities, capabilities, traffic patterns, and other characteristics.

Additionally, there exist numerous different wireless communication technologies (also referred to as radio access technologies (RATs)) and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), BLUETOOTH′, etc. In some implementations, multiple wireless communication technologies may utilize a shared frequency range. For example, various cellular communication modes, such as LTE in Unlicensed spectrum (LTE-U), Licensed Assisted Access (LAA), and NR-U may all utilize frequency bands also used by Wi-Fi, which may lead to interference and congestion of the communication medium. In some scenarios, Bluetooth may also operate within the shared frequency range.

Each new wireless communication technology or mode that is designed to operate within a frequency band already utilized by another technology may further exacerbate these problems. Accordingly, new techniques in the field are desired to allow improved coexistence of various wireless communication standards operating within the same frequency range.

### SUMMARY

Embodiments are presented herein of, inter alia, systems, apparatuses, and methods for performing techniques for coexistence of multiple radio access technologies (RATs) within a shared frequency range for wireless communication. According to the techniques described herein, a wireless communication device may utilize communication protocols according to multiple RATs within the shared frequency range, in a manner that reduces or avoids interference and collisions.

A wireless communication device is presented, which may include a first radio and a second radio. The first radio may be configured to communicate according to a first RAT within a specified frequency range, wherein the first RAT supports a superframe signal format that includes communication periods separated by one or more non-communication periods within a superframe, a non-communication period duration being longer than a communication period duration. The second radio may be configured to communicate according to a second RAT within at least a portion of the specified frequency range during at least one of the one or more non-communication periods within the superframe. The second radio may be further configured to suspend communications according to the second RAT during at least a subset of the communication periods of the superframe.

In some scenarios, the second radio may be configured to remain in an active state while suspending communications according to the second RAT during the at least a subset of the communication periods of the superframe. In some scenarios, the second radio may be configured to remain in the active state while suspending communications according to the second RAT during all communication periods of the first RAT.

In some scenarios, the second radio may be configured to suspend communications according to the second RAT during the at least a subset of the communication periods of the superframe, without notifying a remote device of the suspension of communications, wherein the second radio has an established communication link with the remote device according to the second RAT.

In some scenarios, the wireless communication device may further include a shared antenna, configured to switch between a communicative connection to the first radio and a communicative connection to the second radio. The antenna may be configured to communicatively connect to the second radio while the second radio is communicating according to the second RAT, and to communicatively connect to the first radio while the second radio has suspended communications according to the second RAT.

In some scenarios, the wireless communication device may further include an application processor configured to provide instruction to the shared antenna regarding to which radio the shared antenna is to connect.

In some scenarios, the superframe signal format may constrain the total duration of the communication periods of the superframe to occupy not more than a predefined percentage of the duration of the superframe.

In some scenarios, each communication period of the superframe may be immediately followed by a non-communication period having a duration of at least a predefined multiple of the duration of the respective communication period.

In some scenarios, the second radio may be configured to continue communications according to the second RAT within the at least a portion of the specified frequency range during a communication period of the first RAT, while the second radio is performing an operation included in a predefined set of high-priority operations.

In some scenarios, the first radio may be configured to communicate to the second radio a first indication of whether the first radio is performing a communication period. In some scenarios, the second radio may be configured to communicate to the first radio a second communication of whether the second radio is performing a high-priority operation.

A method is disclosed for operating a wireless communication device using a first radio access technology (RAT) and a second RAT. The wireless communication device may establish a communication link with a remote device within a specified frequency range according to the second RAT. The wireless communication device may communicate via a superframe within at least a portion of the specified frequency range according to the first RAT, while the communication link with the remote device remains established according to the second RAT. The superframe may include at least two communication periods separated by at least one non-communication period. The wireless communication device may suspend communications according to the second RAT during a communication period of the superframe, and may continue communications according to the second RAT upon conclusion of the communication period, during a non-communication period of the at least one non-communication period.

In some scenarios, the wireless communication device may determine that the wireless communication device is performing a high-priority operation according to the second RAT, and, in response to the determining, may continue communication according to the second RAT during a communication period of the superframe.

In some scenarios, a sum of durations of the communication periods of the superframe is not greater than a specified threshold value.

In some scenarios, the specified threshold value may be dynamically configurable.

In some scenarios, each non-communication period of the superframe is longer, by at least a specified factor, than an immediately preceding communication period of the superframe.

In some scenarios, the suspending communications according to the second RAT may be performed without notifying the remote device of the suspension.

In some scenarios, the wireless communication device may connect a shared antenna to a radio operating according to the first RAT during the communication periods, and connect the shared antenna to a radio operating according to the second RAT during the non-communication periods.

An apparatus is disclosed for implementing the preceding method according to any of the disclosed scenarios.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system, according to various exemplary embodiments described herein.

FIGS. 2-3 are block diagrams illustrating example wireless devices, according to various exemplary embodiments described herein.

FIG. 4 shows an example of a superframe signal format for a comb protocol, according to some embodiments.

FIG. 5 shows a block diagram of an example antenna switch configuration for a shared antenna, according to some embodiments.

FIG. 6 illustrates a flow diagram of one method of performing coexistence between a comb protocol and one or more other protocols, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™ PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer system devices which performs wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” (also called “eNB” or “gNB”) has the full breadth of its ordinary meaning, and at least includes a wireless communication station installed at a fixed location and used to communicate as part of a wireless cellular communication system.

Link Budget Limited—includes the full breadth of its ordinary meaning, and at least includes a characteristic of a wireless device (e.g., a UE) which exhibits limited communication capabilities, or limited power, relative to a device that is not link budget limited, or relative to devices for which a radio access technology (RAT) standard has been developed. A wireless device that is link budget limited may experience relatively limited reception and/or transmission capabilities, which may be due to one or more factors such as device design, device size, battery size, antenna size or design, transmit power, receive power, current transmission medium conditions, and/or other factors. Such devices may be referred to herein as “link budget limited” (or “link budget constrained”) devices. A device may be inherently link budget limited due to its size, battery power, and/or transmit/receive power. For example, a smart watch that is communicating over LTE or LTE-A with a base station may be inherently link budget limited due to its reduced transmit/receive power and/or reduced antenna. Wearable devices, such as smart watches, are generally link budget limited devices. Alternatively, a device may not be inherently link budget limited, e.g., may have sufficient size, battery power, and/or transmit/receive power for normal communications over LTE or LTE-A, but may be temporarily link budget limited due to current communication conditions, e.g., a smart phone being at the edge of a cell, etc. It is noted that the term “link budget limited” includes or encompasses power limitations, and thus a power limited device may be considered a link budget limited device.

Processing Element (or Processor)—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

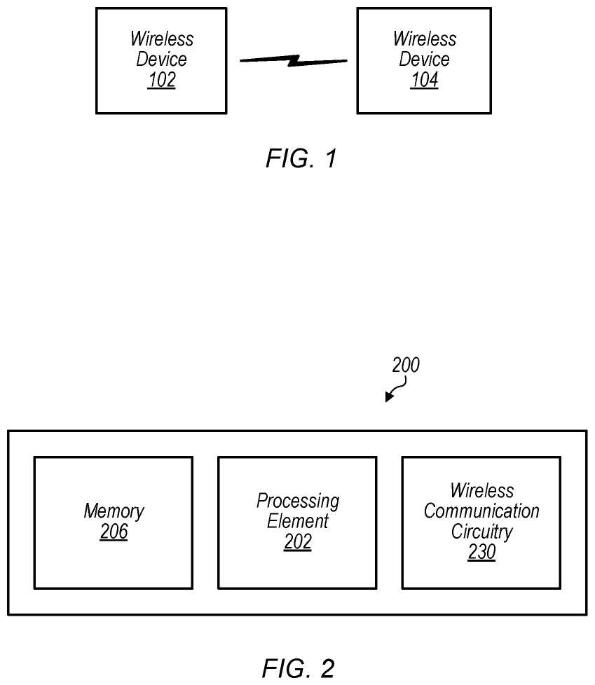

### FIG. 1—Wireless Communication System

FIG. 1 illustrates an exemplary (and simplified) wireless communication system 100 in which aspects of this disclosure may be implemented. It is noted that the system of FIG. 1 is merely one example of a possible system, and embodiments of this disclosure may be implemented in any of various systems, as desired.

As shown, the exemplary wireless communication system includes a (“first”) wireless device 102 in communication with another (“second”) wireless device 104. The first wireless device 102 and the second wireless device 104 may communicate wirelessly using any of a variety of wireless communication techniques.

As one possibility, the first wireless device 102 and the second wireless device 104 may communicate using techniques based on WPAN or WLAN wireless communication, such as 802.11/Wi-Fi. One or both of the wireless device 102 and the wireless device 104 may also be capable of communicating via one or more additional wireless communication protocols, such as a comb protocol as described herein, and/or any of Bluetooth (BT), Bluetooth Low Energy (BLE), near field communication (NFC), GSM, UMTS (WCDMA, TDSCDMA), LTE, LTE-Advanced (LTE-A), NR, 3GPP2 CDMA2000 (e.g., 1×RTT, 1×EV-DO, HRPD, eHRPD), Wi-MAX, GPS, etc.

The wireless devices 102, 104 may be any of a variety of types of wireless device. As one possibility, one or more of the wireless devices 102, 104 may be a substantially portable wireless user equipment (UE) device, such as a smart phone, hand-held device, a wearable device, a tablet, a motor vehicle, or virtually any type of mobile wireless device. As another possibility, one or more of the wireless devices 102, 104 may be a substantially stationary device, such as a set top box, media player (e.g., an audio or audiovisual device), gaming console, desktop computer, appliance, door, base station, access point, or any of a variety of other types of device.

Each of the wireless devices 102, 104 may include wireless communication circuitry configured to facilitate the performance of wireless communication, which may include various digital and/or analog radio frequency (RF) components, a processor that is configured to execute program instructions stored in memory, a programmable hardware element such as a field-programmable gate array (FPGA), and/or any of various other components. The wireless device 102 and/or the wireless device 104 may perform any of the method embodiments described herein, or any portion of any of the method embodiments described herein, using any or all of such components.

Each of the wireless devices 102, 104 may include one or more antennas for communicating using one or more wireless communication protocols. In some cases, one or more parts of a receive and/or transmit chain may be shared between multiple wireless communication standards. For example, a device might be configured to communicate using either of Bluetooth or Wi-Fi using partially or entirely shared wireless communication circuitry (e.g., using a shared radio or at least shared radio components). The shared communication circuitry may include a single antenna, or may include multiple antennas (e.g., for MIMO) for performing wireless communications. Alternatively, a device may include separate transmit and/or receive chains (e.g., including separate antennas and other radio components) for each wireless communication protocol with which it is configured to communicate. As a further possibility, a device may include one or more radios or radio components which are shared between multiple wireless communication protocols, and one or more radios or radio components which are used exclusively by a single wireless communication protocol. For example, a device might include a shared radio for communicating using either of LTE or CDMA2000 1×RTT, and separate radios for communicating using each of a comb protocol, Wi-Fi, and/or Bluetooth. Other configurations are also possible.

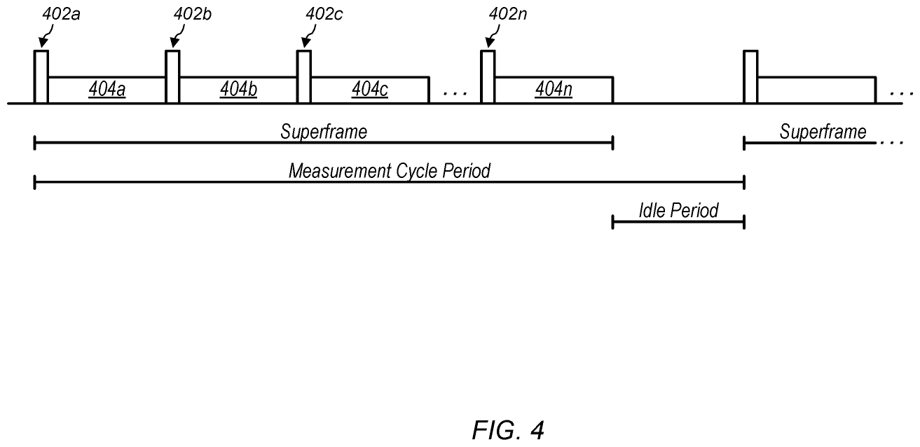

As previously noted, aspects of this disclosure may be implemented in conjunction with the wireless communication system of FIG. 1. For example, the wireless devices 102, 104 may communicate using one or more coexistence techniques or features described subsequently herein with respect to FIGS. 4-6. By utilizing such techniques (and/or other techniques described herein), the wireless device(s) may (at least according to some embodiments) be able to reduce interference and/or congestion, while communicating according to a plurality of wireless communication technologies.

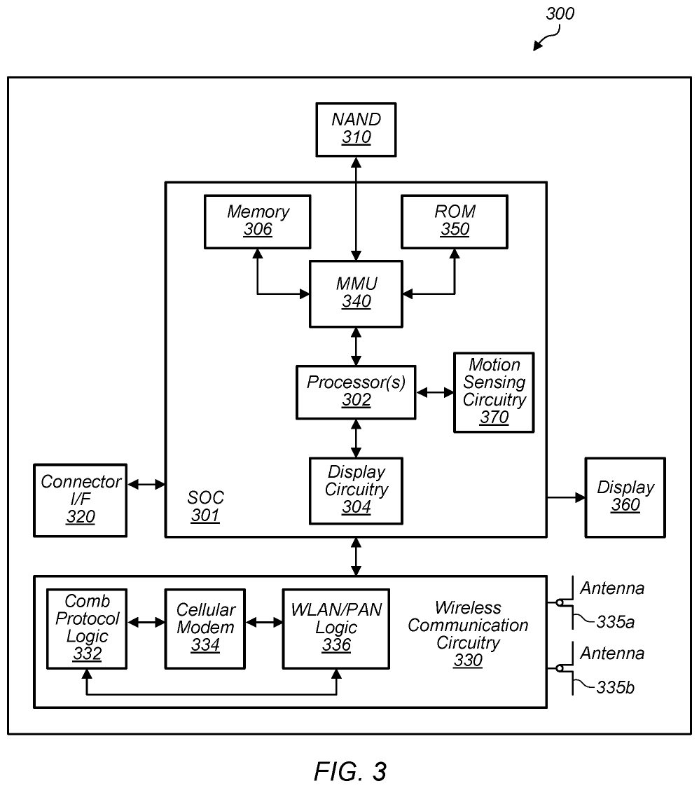

### FIGS. 2-3—Exemplary Device Block Diagrams

FIG. 2 illustrates an exemplary wireless device 200 that may be configured for use in conjunction with various aspects of the present disclosure. For example, the device 200 may be an example of the wireless device 102 or the wireless device 104. The device 200 may be any of a variety of types of device and may be configured to perform any of a variety of types of functionality. The device 200 may be a substantially portable device or may be a substantially stationary device, potentially including any of a variety of types of device. The device 200 may be configured to perform one or more wireless communication coexistence techniques or features, such as any of the techniques or features illustrated and/or described subsequently herein with respect to any or all of FIGS. 4-6.

As shown, the device 200 may include a processing element 202. The processing element may include or be coupled to one or more memory elements. For example, the device 200 may include one or more memory media (e.g., memory 206), which may include any of a variety of types of memory and may serve any of a variety of functions. For example, memory 206 could be RAM serving as a system memory for processing element 202. Other types and functions are also possible.

Additionally, the device 200 may include wireless communication circuitry 230. The wireless communication circuitry may include any of a variety of communication elements (e.g., antenna for wireless communication, analog and/or digital communication circuitry/controllers, etc.) and may enable the device to wirelessly communicate using one or more wireless communication protocols.

Note that in some cases, the wireless communication circuitry 230 may include its own processing element (e.g., a baseband processor and/or control processor), e.g., in addition to the processing element 202. For example, the processing element 202 might be (or include) an ‘application processor’ whose primary function may be to support application layer operations in the device 200, while the wireless communication circuitry 230 might include a ‘baseband processor’ whose primary function may be to support baseband layer operations (e.g., to facilitate wireless communication between the device 200 and other devices) in the device 200. In other words, in some cases the device 200 may include multiple processing elements (e.g., may be a multi-processor device). Other configurations (e.g., instead of or in addition to an application processor/baseband processor configuration) utilizing a multi-processor architecture are also possible.

The device 200 may additionally include any of a variety of other components (not shown) for implementing device functionality, depending on the intended functionality of the device 200, which may include further processing and/or memory elements (e.g., audio processing circuitry), one or more power supply elements (which may rely on battery power and/or an external power source), user interface elements (e.g., display, speaker, microphone, camera, keyboard, mouse, touchscreen, etc.), sensors, and/or any of various other components.

The components of the device 200, such as processing element 202, memory 206, and wireless communication circuitry 230, may be operatively coupled via one or more interconnection interfaces, which may include any of a variety of types of interface, possibly including a combination of multiple types of interface. As one example, a USB high-speed inter-chip (HSIC) interface may be provided for inter-chip communications between processing elements. Alternatively (or in addition), a universal asynchronous receiver transmitter (UART) interface, a serial peripheral interface (SPI), inter-integrated circuit (I2C), system management bus (SMBus), and/or any of a variety of other communication interfaces may be used for communications between various device components. Other types of interfaces (e.g., intra-chip interfaces for communication within processing element 202, peripheral interfaces for communication with peripheral components within or external to device 200, etc.) may also be provided as part of device 200.

FIG. 3 illustrates one possible block diagram of a wireless device 300, which may be one possible exemplary implementation of the device 200 illustrated in FIG. 2. As shown, the wireless device 300 may include a system on chip (SOC) 301, which may include portions for various purposes. For example, as shown, the SOC 301 may include processor(s) 302, which may execute program instructions for the wireless device 300, and display circuitry 304, which may perform graphics processing and provide display signals to the display 360. The SOC 301 may also include motion sensing circuitry 370, which may detect motion of the wireless device 300, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, flash memory 310). The MMU 340 may be configured to perform memory protection and page table translation or set up. In some embodiments, the MMU 340 may be included as a portion of the processor(s) 302.

As shown, the SOC 301 may be coupled to various other circuits of the wireless device 300. For example, the wireless device 300 may include various types of memory (e.g., including NAND flash 310), a connector interface 320 (e.g., for coupling to a computer system, dock, charging station, etc.), the display 360, and wireless communication circuitry 330 (e.g., for UWB, LTE, LTE-A, CDMA2000, Bluetooth, Wi-Fi, NFC, GPS, etc.).

The wireless device 300 may include at least one antenna, and in some embodiments multiple antennas 335a and 335b, for performing wireless communication with base stations and/or other devices. For example, the wireless device 300 may use antennas 335a and 335b to perform the wireless communication. As noted above, the wireless device 300 may in some embodiments be configured to communicate wirelessly using a plurality of wireless communication standards or radio access technologies (RATs).

The wireless communication circuitry 330 may include Comb Protocol Logic 332, a Cellular Modem 334, and additional WLAN/PAN Logic 336. The Comb Protocol Logic 332 enables the wireless device 300 to perform Comb Protocol communications, e.g., for wireless communications as described herein. The WLAN/PAN Logic 336 enables the wireless device 300 to perform other WLAN and/or PAN communications, such as Wi-Fi and/or Bluetooth communications. In some scenarios, the WLAN/PAN Logic 336 main include distinct circuitry for performing communications according to distinct protocols, such as a first portion of circuitry for performing Wi-Fi communications and a second portion of circuitry for performing Bluetooth communications. In some scenarios, the WLAN/PAN Logic 336 main also, or alternatively, include shared circuitry for performing communications according to multiple protocols, such as both Wi-Fi and Bluetooth. The cellular modem 334 may be capable of performing cellular communication according to one or more cellular communication technologies. In some scenarios, each of the Comb Protocol Logic 332, the Cellular Modem 334, and the WLAN/PAN Logic 336, or some portion thereof may be referred to as a radio. For example, the Comb Protocol Logic 332 may be referred to as, or may include, a comb protocol radio; the Cellular Modem 334 may be referred to as, or may include, a cellular radio; and/or the WLAN/PAN Logic 336 may be referred to as, or may include, one or more of a WLAN radio, a PAN radio, a Wi-Fi radio, a BT radio, etc.

Note that in some cases, one or more of the Comb Protocol Logic 332, the Cellular Modem 334, or the WLAN/PAN Logic 336 may include its own processing element (e.g., a baseband processor and/or control processor), e.g., in addition to the processor(s) 302. For example, the processor(s) 302 might be (or include) an ‘application processor’ whose primary function may be to support application layer operations in the device 300, while one or more of the Comb Protocol Logic 332, the Cellular Modem 334, or the WLAN/PAN Logic 336 may include a ‘baseband processor’ whose primary function may be to support baseband layer operations for the applicable RAT.

As described herein, wireless device 300 may include hardware and software components for implementing embodiments of this disclosure. For example, one or more components of the wireless communication circuitry 330 (e.g., Comb Protocol Logic 332 and/or WLAN/PAN Logic 336) of the wireless device 300 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

### FIG. 4—Comb Protocol

Certain radio access technologies (RATs) may be referred to as, or may implement, comb protocols. A comb protocol may be characterized by the structure of a superframe signal format utilized by the protocol. Specifically, a comb protocol may support (e.g., be characterized by) a superframe signal format that includes communication periods separated by non-communication periods within the superframe. Such a protocol may allow radio implementations characterized by transmitting and/or receiving a short (e.g., a fraction of a millisecond) burst of data (e.g., a single frame), followed by a long processing time (e.g., 2 ms or more) during which a receiving device may process the received data and transition from RX mode to TX mode. During that long processing time, the radio may not transmit or receive additional bursts of data. Certain Ultra Wideband (UWB) protocols, among other protocols, such as certain modes of BT or Wi-Fi communications, may fall into the category of comb protocols.

FIG. 4 illustrates an example of a superframe signal format for a comb protocol, according to some embodiments. As illustrated in FIG. 4, a superframe may include a plurality of communication periods 402a-402n, separated by a plurality of non-communication periods 404a-404n. For example, each communication period of the superframe may be immediately followed by a non-communication period. As another example, each adjacent pair of communication periods may be separated by a non-communication period (thus distinguishing from the previous example by the omission of the trailing non-communication period 404n). The term “comb protocol” is based on the shape of such a superframe, wherein the communication periods resemble the teeth of a comb, as may be seen in FIG. 4.

In some scenarios, the communication periods of a superframe may have a first time duration, and the non-communication periods of the superframe may have a second, different time duration. In other scenarios, the duration of a communication period may be different from, or independent of, the durations of other communication periods, and/or the duration of a non-communication period may be different from, or independent of, the durations of other non-communication periods. However, a typical characteristic of a comb protocol is that the non-communication periods have duration(s) that are substantially (e.g., several times) longer than the duration(s) of the communication periods. For example, in some scenarios, the duration of the non-communication periods may be a predefined multiple N of the duration of the communication periods. In some scenarios, N may be an integer value, e.g., not less than 2. In other scenarios, N may be a non-integer value, e.g., greater than 2, etc. In other examples, the duration of the non-communication periods may not be determined based on, or otherwise related to, the duration of the communication periods, but may nevertheless be substantially longer than the duration of the communication periods.

The number of communication periods within a superframe may be fixed or dynamic, in various implementations, and may have fixed or dynamic durations. Superframes may be transmitted regularly, e.g., according to a defined measurement cycle period, wherein a superframe transmission is initiated one measurement cycle period after initiation of the preceding superframe. In some scenarios, an idle period may occur between consecutive superframes, the idle period having a duration that is the difference between the duration of the measurement cycle period and the duration of a superframe. Thus, the duration of the idle period may be fixed or dynamic.

In some implementations, a comb protocol may utilize a frequency range (or set of frequencies) shared with one or more other RATs. For example, a comb protocol may utilize at least a portion of the 5 GHz band, which may also be utilized by certain modes of Wi-Fi and/or unlicensed cellular communications, such as LAA or LTE-U. This is a particular problem when a single wireless communication device, such as the wireless device 102, attempts to communicate using two or more of these competing RATs simultaneously. Similar problems may occur in other frequency ranges, as well, such as the 2.4 GHz band, or any other frequency range in which multiple radios contend for the communication medium according to different RATs, using time-division multiplexing. In such scenarios, some coexistence scheme should be applied, to avoid collisions and scheduling conflicts between the various RATs.

The traditional approach to multi-RAT coexistence has been to negotiate control of the communication medium for each frame or superframe, while radios not currently in control of the medium may enter a power-save state until the next opportunity to gain control of the medium. For example, when a cellular radio of a wireless device takes control of the medium to implement LAA communications, the wireless device may cause its Wi-Fi radio to publicly surrender the medium while the cellular radio transmits or receives one or more LAA frames (e.g., 10 ms). For example, the Wi-Fi radio may enter a sleep mode, which may include notifying an AP (or other remote communication device with which the Wi-Fi radio has an established communication link) that the Wi-Fi radios will be in the sleep mode, to prevent the AP from attempting to contact the Wi-Fi radio while it is in the sleep mode. Alternatively, the Wi-Fi radio may transmit a clear-to-send (CTS)-to-self message, to indicate that the medium will be occupied for a specified period of time. This approach similarly prevents an AP or other remote device from attempting to contact the Wi-Fi radio during transmission of the LAA frames.

However, some use cases of comb protocols make this approach impractical. For example, in some implementations, a comb protocol may utilize a long superframe. Depending on various factors, such as the specific protocol used, the communication range, the use case, and the hardware implementation, the communication packet size may vary. Reasonable example packet sizes, measured in transmission time, may include 160 us, 200 us, 1400 us, 3200 us, or other values. The comb protocol is adapted such that each communication period may accommodate at least one packet. As previously noted, the turnaround time between each communication period may be significantly longer. Additionally, the superframe may include a plurality (e.g., 20-50 or more) of communication periods. All of these factors may result in a total superframe length that introduces problems for coexistence with other protocols.

As one example of a specific reasonable implementation, an example comb protocol may include a plurality of communication periods, each having a fixed duration (e.g., 250 us), and each immediately followed by a respective non-communication period (e.g., 2.25 ms). The superframe may have a fixed or variable duration, e.g., in the range of 50 ms-120 ms. In other implementations, other timings may be used.

In such an example, the traditional approach to coexistence would require the Wi-Fi radio, and other radios, to surrender the medium and forego communications for as long as 120 ms. However, this may not be practical for implementing the Wi-Fi protocols, which may require more frequency communications.

Additionally, some use cases, such as precise ranging, may dictate that the comb protocol radio exchange multiple packets within a short time, or on a regular schedule, such that superframes should be sent with very short gap between consecutive superframes, or nearly back-to-back. For example, in the specific example implementation defined above, the comb protocol may utilize a measurement cycle period of 180 ms. With a superframe duration of up to 120 ms, this may leave as little as 60 ms between superframes, which may be insufficient time for the Wi-Fi radio, and/or other radios, to complete their communications. Other values of the measurement cycle period are also possible, but may similarly leave insufficient time for other radios.

A similar problem may be introduced during initial synchronization between devices communicating via a comb protocol. Specifically, comb protocols may be synchronized protocols, meaning that the transmitting device and the receiving device may synchronize to expect comb protocol communications at certain times (or predict communication instances). For example, in some implementations, each superframe may begin with, or otherwise include, a poll frame. Such a poll frame may include synchronization information, and may also include information regarding the transmission time of the next superframe. Additionally, in some implementations, various frames within the superframe may be directed to different receiving devices. In such scenarios, the poll frame may include information identifying which communication periods of the superframe contain frames addressed, or otherwise directed, to each receiving device. Thus, once a transmitting device and a receiving device are synchronized, the receiving device may receive subsequent superframes by listening only at the appropriate times, when it expects an applicable communication period to occur.

However, prior to synchronization, the receiving device may be unaware of when a poll frame may occur. Thus, initial synchronization may involve the comb protocol radio listening on the communication channel for an extended period of time, until it receives a poll frame for synchronization. As noted above, communications according to other protocols, such as Wi-Fi, may be disrupted by surrendering the communication medium for such an extended period.

Alternatively, or additionally, comb protocol synchronization may be performed using out-of-band signaling. For example, a receiving device may determine when a poll frame may occur, based on information obtained from a signal received outside the frequency range in which the superframes are communicated. In some scenarios, such out-of-band signaling may be a part of (e.g., defined by) the comb protocol, and/or may be transmitted by a comb protocol radio. In some scenarios, such out-of-band signaling may be part of another protocol. For example, comb protocol superframes may be aligned with (or otherwise timed according to) BT advertisements, or other predictable timing signals transmitted according to another protocol. As another example, a wireless device capable of communicating according to both a comb protocol and another protocol (e.g., BT, BLE, etc.), may transmit and/or receive out-of-band signaling according to the other protocol (e.g., using a radio other than the comb protocol radio) expressly to communicate synchronization information for the comb protocol.

Coexistence with Comb Protocols

In light of the considerations outlined above, a coexistence scheme for a comb protocol may include a different approach than traditional coexistence schemes. Specifically, it may be noted that, although comb protocol superframes may occupy the communication medium for a significant amount (e.g., a majority) of available time, the comb protocol may actually utilize the communication medium for only a small percentage of that time. In particular, in some implementations, the communication periods of the comb protocol may be sufficiently short to allow implementation of the comb protocol concurrently with another protocol, without significantly disrupting the other protocol.

For example, in some scenarios, a wireless device including a Wi-Fi radio and a comb protocol radio (e.g., UWB) may be operating to communicate with a remote device via Wi-Fi, at a time when a comb protocol superframe is scheduled to begin on the same frequency range (e.g., the same communication channel). It should be understood that use of the Wi-Fi radio in this scenario is merely exemplary, and, in other scenarios, another radio or RAT may be substituted. At, or shortly before, the start of the comb protocol superframe, the wireless device (e.g., an application processor or comb protocol radio of the wireless device) may notify the Wi-Fi radio that the comb protocol radio will take control of the communication medium for the duration of the first communication period of the superframe.

In response, the Wi-Fi radio may forego transmitting or receiving during the first communication period. However, the Wi-Fi radio may remain in an active state throughout the first communication period. For example, the Wi-Fi radio may forego entering a sleep state (or lower power state), e.g., because the first communication period is too short to make a transition to the sleep state power-efficient. Thus, the Wi-Fi radio may also not notify the remote device (or any remote devices) that it is entering a sleep state. As another example, the Wi-Fi radio may forego transmitting a CTS-to-self message. More generally, the Wi-Fi radio may continue operating according to its normal active mode, with the exception that the radio does not transmit (or, in some implementations, does not transmit or receive) during the first communication period of the comb protocol superframe. The first communication period may be sufficiently brief that it does not represent a significant interruption to the Wi-Fi communications. Thus, no additional action is warranted by the Wi-Fi radio.

During the first communication period of the comb protocol superframe, the comb protocol radio may transmit and/or receive on the communication channel, as appropriate.

Following the first communication period, the comb protocol radio may cease transmitting and/or receiving on the channel, and the Wi-Fi radio may resume normal operations. This pattern may be repeated for subsequent communication periods of the comb protocol superframe.

If the communication periods are sufficiently short, then most Wi-Fi use cases may be unimpeded by the interruption by the comb protocol. For example, in scenarios in which the Wi-Fi radio would otherwise be scheduled to transmit within a communication period, the Wi-Fi radio may instead delay the transmission until after the communication period. In most use cases, this delay may be within a delay window that is considered acceptable within the Wi-Fi protocol. In scenarios in which a remote device transmits a Wi-Fi signal, or a portion thereof, for the wireless device during a comb protocol communication window, the Wi-Fi radio may address the loss through normal error-protection or signal-loss correction methods. If the communication periods are sufficiently short, such losses may be acceptably minor.

Various techniques may be used to ensure the comb protocol allows sufficient non-communication time within the superframe to accommodate communications by other protocols. For example, in some scenarios, the comb protocol may be constrained such that the communication periods occupy no more than a predefined threshold percentage of the superframe. For example, the communication periods may be limited to no more than 10% of the superframe, while the non-communication periods occupy the remaining 90%. In some scenarios, this may include defining the communication periods to have a fixed duration of Xms and the non-communication periods to have a fixed duration of at least 9*Xms. In other scenarios, the communication periods may be dynamic in length. In such scenarios, the comb protocol radio may operate such that each communication period is followed by a non-communication period at least 9 times as long, such that the sum of the communication periods of the superframe does not exceed 10% of the duration of the superframe. In other examples, the threshold percentage may be defined as any value other than 10%, and the multipliers may be adjusted accordingly.

In some implementations, the threshold percentage may be dynamically adjustable. For example, if radios other than the comb protocol radio are being interrupted by the comb protocol radio too frequently, the threshold percentage may be reduced. More generally, the threshold percentage may be reduced if communications via one or more radios other than the comb protocol radio are failing to meet a specified performance threshold, particularly if communications via the comb protocol radio are meeting a specified performance threshold. As another example, if the Wi-Fi radio, or another radio, is performing testing or other extended operation that should not be interrupted (e.g., a critical operation), the threshold percentage may be changed to 0%, to prevent the comb radio from taking control of the communication medium or other communication resource(s).

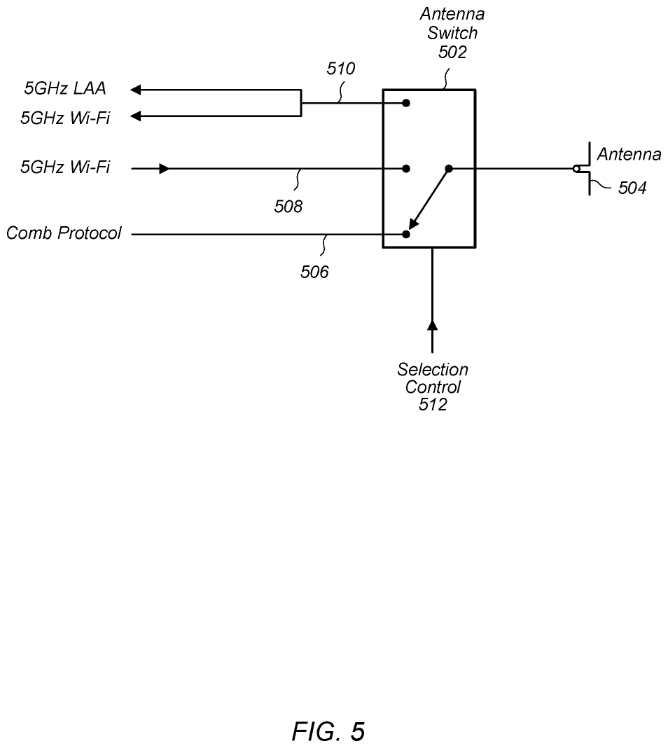

In some implementations, the comb protocol radio may share an antenna with one or more other radios. FIG. 5 illustrates a block diagram of an example of such an implementation, according to some embodiments. Specifically, FIG. 5 illustrates a block diagram of an antenna switch configuration, according to some embodiments. The antenna switch configuration of FIG. 5 may be included in a wireless communication device (e.g., the wireless device 102, 200, or 300). For example, the antenna switch configuration of FIG. 5 may be included in the wireless communication circuitry 330 of FIG. 3. It should be understood that the block diagram of FIG. 5 is simplified for clarity, and that additional components (e.g., amplifiers, attenuators, etc.) may be present in a physical implementation, although not shown here.

As illustrated in FIG. 5, an antenna switch 502 may connect a shared antenna 504 with any of a plurality of input or output lines. In some implementations, the antenna 504 may be equivalent to the antenna 335a or 335b of FIG. 3. The antenna switch 502 is illustrated as including an input/output line 506, which may provide a comb protocol signal to the antenna 504 for transmission and/or provide a received signal from the antenna 504 to a comb protocol radio; an input line 508, which may provide a 5 GHz Wi-Fi signal to the antenna 504 for transmission; and an output line 510, which may provide a received signal from the antenna 504 to either a 5 GHz Wi-Fi radio or to an LTE radio for 5 GHz LAA communications. It should be understood that these inputs and outputs are merely examples, and additional and/or other inputs/outputs may be included in other implementations. As illustrated in FIG. 5, a selection control signal 512 may also be provided to the antenna switch 502. The selection control signal 512 may control which input/output is connected to the antenna 504 by the antenna switch 502, and may be provided, e.g., by an application processor or by control logic communicatively coupled to one or more radio modules (e.g., within the wireless communication circuitry 330 of FIG. 3).

In some scenarios, the antenna switch configuration of FIG. 5 (or a similar antenna switch configuration) may facilitate transferring control of the communication medium between multiple radios. For example, in a scenario in which a comb protocol radio is sharing the communication medium with a Wi-Fi radio (e.g., as described above), the antenna switch 502 may be configured (e.g., via the selection control signal 512) to connect the comb protocol radio (e.g., the input/output line 506) to the antenna 504 during the communication periods of the comb protocol superframe, to allow the comb protocol radio to transmit and/or receive via the antenna 504. The antenna switch 502 may be further configured to connect the Wi-Fi radio (e.g., the input line 508 or the output line 510) to the antenna 504 during the non-communication periods, and/or during idle periods outside of the superframe, to allow the Wi-Fi radio to transmit and/or receive via the antenna 504. This arrangement may allow very fast switching between the two radios.

In some scenarios, the preceding approach may still include disruptions to communications according to Wi-Fi or other protocols that may be deemed to be unacceptable. For example, a protocol may include certain high-priority or critical operations that should not be delayed or interrupted. For example, a Wi-Fi radio may perform physical layer (PHY) calibrations approximately once every 5 minutes. Such calibrations may occupy the communication channel for approximately 30 ms, and should not be interrupted. As another example, a Wi-Fi radio may prioritize listening for a synchronization beacon in some scenarios, e.g., following a threshold number of consecutive beacons being missed. In some implementations, the wireless device may maintain a predefined set of such high-priority operations. In such scenarios, the wireless device may be configured to allow the Wi-Fi radio to maintain control of the communication medium (and a shared antenna, if applicable) during the communication periods of a comb protocol superframe to accommodate such high-priority operations; e.g., while performing an operation included in the predefined set of high-priority operations. In some scenarios, a high-priority operation may not be included on a list, but may instead be determined dynamically, e.g., based on an efficiency determination. For example, the Wi-Fi radio (or other radio) may receive an extended block communication, and may be scheduled to transmit a block acknowledgement message (block ACK) within a certain window of time. In such scenarios, failing to transmit the block ACK within the specified window, e.g., because the comb protocol radio has control of the communication medium during a communication period of a superframe, may result in retransmission of the entire block communication. In such scenarios, the wireless device may be configured to determine that failing to transmit the block ACK (and thus receiving retransmission of the block communication) would lead to greater inefficiency than losing a frame of the comb protocol superframe. The wireless device may therefore allow the Wi-Fi radio to maintain (or seize) control of the communication medium (and a shared antenna, if applicable) during a communication period of the superframe to allow transmission of the block ACK. Other high-priority operations are also envisioned.

In some implementations, one or more radios of the wireless device may communicate, e.g., to each other, to an application processor, etc., information regarding their current operational state. For example, the Wi-Fi radio may indicate whether it is currently performing a high-priority operation (e.g., a critical operation). The wireless device, or components thereof, may respond to this indication in various ways. For example, in some implementations, the comb protocol radio may receive the indication from the Wi-Fi radio, and may respond by suspending communications according to the comb protocol until the Wi-Fi radio has completed the high-priority operation. In some implementations, the antenna switch 502 may receive the indication from the Wi-Fi radio, e.g., via the selection control signal 512, and may respond by connecting the Wi-Fi radio to the shared antenna 504 until the Wi-Fi radio has completed the high-priority operation. In some implementations, an application processor may receive the indication from the Wi-Fi radio, and may take appropriate steps, such as causing the antenna switch 502 to connect the Wi-Fi radio to the shared antenna 504 and/or causing the comb protocol radio to suspend operations.

As another example, the comb protocol radio may indicate whether it is actively performing communications (e.g., transmitting or receiving). In some scenarios, the Wi-Fi radio may receive the indication from the comb protocol radio, and may respond by suspending Wi-Fi communications until the comb protocol radio completes its communications. In some implementations, the antenna switch 502 may receive the indication from the comb protocol radio, e.g., via the selection control signal 512, and may respond by connecting the comb protocol radio to the shared antenna 504 until the comb protocol radio has completed the its communications. In some implementations, an application processor may receive the indication from the comb protocol radio, and may take appropriate steps, such as causing the antenna switch 502 to connect the comb protocol radio to the shared antenna 504 and/or causing the Wi-Fi radio to suspend communications. In some scenarios, the Wi-Fi radio may have no specific knowledge regarding the timing of the communication periods of the comb protocol superframe, but may suspend Wi-Fi communications during the communication periods, as discussed above, in response to receiving the indication from the comb protocol radio or receiving an instruction from the application processor.

In some implementations, the application processor and/or the antenna switch 502 may operate based on inputs from multiple radios. For example, in some implementations, the Wi-Fi radio may indicate whether it is currently performing a high-priority operation, and the comb protocol radio may indicate whether it is actively performing communications. As a result (e.g., in response to receiving the indications or in response to receiving an instruction from the application processor, as a result of the application processor receiving the indications), the antenna switch 502 may connect the comb protocol radio to the shared antenna 504 if the comb protocol radio is actively performing communications and the Wi-Fi radio is not performing a high-priority operation, and may connect the shared antenna 504 to the Wi-Fi radio in other cases (e.g., in all other cases).

In some implementations, one or more indications from the radios may begin shortly before the indicated status change takes effect. For example, the Wi-Fi radio may indicate that it will shortly begin performing a high-priority operation, and/or the comb protocol radio may indicate that it will shortly begin performing communications. In this manner, other radios may be given sufficient advance notice to take action, such as delaying imminent communications. In some implementations, the amount of lead time (e.g., the amount of time between the start of the indication and the status change) may be dynamically configurable. In implementations including a shared antenna, changing the state of the antenna switch 502 may be delayed after the start of the indication, e.g., so as to coincide with the status change.

In some implementations, the wireless device may include a plurality of antennas or antenna arrays for wireless communications, e.g., instead of, or in addition to the shared antenna 504. For example, one or more of the radios may have a dedicated antenna or antenna array. In such scenarios, multiple radios may be capable of communicating simultaneously, but may risk desensing each other, e.g., if one transmits while the other receives. However, it may be possible for two or more radios to receive simultaneously without desense. For example, in some scenarios, the Wi-Fi radio may continue to receive during a communication period of the comb protocol superframe, if the comb protocol is not transmitting during the communication period.

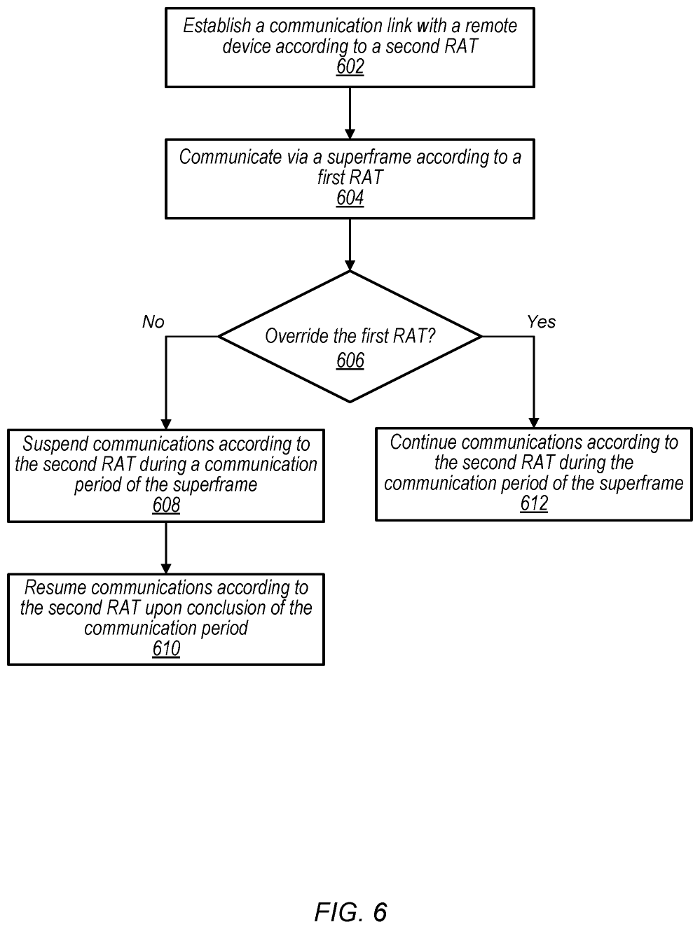

### FIG. 6—Method of Performing Coexistence

FIG. 6 illustrates a flow diagram of one method of performing coexistence between a comb protocol and one or more other protocols, according to some embodiments. The method of FIG. 6 is an example method for implementing the techniques discussed above, and should be interpreted in light of the preceding discussion. The method of FIG. 6 may be performed by a wireless communication device, such as the wireless device 102 or 300, or by a portion thereof, such as the wireless communication circuitry 330, that is capable of performing wireless communications according to a first RAT and according to a second RAT within a shared frequency range.

As illustrated in FIG. 6, the wireless communication device may, at 602, establish a communication link with a remote device, according to the second RAT. For example, the wireless communication device may establish a communication link by camping on a cell, authenticating and associating with an access point or peer device, etc., depending upon the protocol being used. The communication link may be established such that at least a portion of the communication link may be within the shared frequency range. In some scenarios, the shared frequency range may be the 5 GHz band, or a portion thereof, though other frequency ranges are also possible. In some scenarios, the second RAT may be Wi-Fi, Bluetooth, BLE, LAA, or another RAT. Once the communication link has been established, the wireless communication device may perform communications with the remote device via the link.

The wireless communication device may, at 604, communicate via a superframe within the specified frequency range according to the first RAT. This may be performed while the communication link with the remote device remains established according to the second RAT. The first RAT may be a comb protocol, e.g., as defined and discussed above. For example, the first RAT may be a protocol in which the superframe includes communication periods separated by non-communication periods. Communicating via the superframe may include receiving and/or transmitting according to the first RAT during one or more communication periods of the superframe, and not receiving or transmitting according to the first RAT during one or more non-communication periods of the superframe.

The wireless communication device may, at 606, determine whether to override the first RAT. There may be various reasons for overriding the first RAT. For example, the wireless communication device may determine that it is performing a high-priority operation according to the second RAT. Such high-priority operations should not be interrupted, and may therefore warrant overriding the first RAT in order to complete the high-priority operation without interruption.

In response to determining not to override the first RAT, the wireless communication device may, at 608, suspend communications according to the second RAT during a communication period of the superframe. For example, the wireless communication device may suspend communications according to the second RAT to avoid interfering with communications according to the first RAT during the communication period. Suspending communications according to the second RAT may include any of various steps, depending on the implementation and the specific scenario. For example, in some scenarios, the wireless device may switch a shared antenna such that the shared antenna is connected to a first radio performing communications according to the first RAT, and is not connected to a second radio performing communications according to the second RAT. In some scenarios, the wireless communication device may instruct the second radio to forego transmitting and/or receiving during the communication period.

In some scenarios, the wireless device may suspend the communications according to the second RAT without notifying the remote device of the suspension of communications. For example, the wireless device may forego communicating any state change or request to clear the channel.

At the conclusion of the communication period, the wireless communication device may, at 610, resume communications according to the second RAT. This may include any of various steps, depending on the implementation and the specific scenario. For example, in some scenarios, the wireless device may switch the shared antenna such that the shared antenna is connected to the second radio, and is not connected to the first radio. In some scenarios, the wireless communication device may instruct the second radio to resume normal operations.

In response to determining to determining to not override the first RAT, the wireless communication device may, at 612, continue communications according to the second RAT during the communication period. This may include any of various steps, depending on the implementation and the specific scenario. For example, in some scenarios, the wireless device may switch or maintain the shared antenna such that the shared antenna is connected to the second radio, and is not connected to the first radio. In some scenarios, the wireless communication device may instruct the first radio to forego transmitting and/or receiving during the communication period.

It should be understood that he method illustrated in FIG. 6 is merely exemplary, and variations thereof are envisioned. Various steps may be added or removed, or performed in a different order. For example, in some implementations, overriding the first RAT, as shown at 606, may not be supported, such that the wireless device always suspends communications according to the second RAT, as shown at 608-610, during some or all communication periods of the superframe.

In addition to the above-described exemplary embodiments, further embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a wireless device 102 or 104) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless communication device, comprising:
a first radio, configured to communicate according to a first radio access technology (RAT) within a specified frequency range, wherein the first RAT supports a superframe signal format that includes communication periods separated by one or more non-communication periods within a superframe, a of the non-communication period duration being longer than communication period duration; and
a second radio, configured to communicate according to a second RAT within at least a portion of the specified frequency range during at least one of the one or more non-communication periods within the superframe, wherein the second radio is further configured to suspend communications according to the second RAT during at least a subset of the communication periods of the superframe.

2. The wireless communication device of claim 1, wherein the second radio is configured to remain in an active state while suspending communications according to the second RAT during the at least a subset of the communication periods of the superframe.

3. The wireless communication device of claim 1, wherein the second radio is configured to suspend communications according to the second RAT during the at least a subset of the communication periods of the superframe, without notifying a remote device of the suspension of communications, wherein the second radio has an established communication link with the remote device according to the second RAT.

4. The wireless communication device of claim 1, further comprising:
a shared antenna, configured to switch between a communicative connection to the first radio and a communicative connection to the second radio, wherein the antenna is configured to communicatively connect to the second radio while the second radio is communicating according to the second RAT, and to communicatively connect to the first radio while the second radio has suspended communications according to the second RAT.

5. The wireless communication device of claim 4, further comprising:
an application processor configured to provide instruction to the shared antenna regarding to which radio the shared antenna is to connect.

6. The wireless communication device of claim 1, wherein the superframe signal format constrains the total duration of the communication periods of the superframe to occupy not more than a predefined percentage of the duration of the superframe.

7. The wireless communication device of claim 1, wherein each communication period of the superframe is immediately followed by a non-communication period having a duration of at least a predefined multiple of the duration of the respective communication period.

8. The wireless communication device of claim 1, wherein the second radio is configured to continue communications according to the second RAT within the at least a portion of the specified frequency range during a communication period of the first RAT, while the second radio is performing an operation included in a predefined set of high-priority operations.

9. The wireless communication device of claim 1, wherein the first radio is configured to communicate to the second radio a first indication of whether the first radio is performing a communication period, and wherein the second radio is configured to communicate to the first radio a second indication of whether the second radio is performing a high-priority operation.

10. A method of operating a wireless communication device using a first radio access technology (RAT) and a second RAT, the method comprising:
by a wireless communication device:
establishing a communication link with a remote device within a specified frequency range according to the second RAT;
communicating via a superframe, within at least a portion of the specified frequency range, according to the first RAT, while the communication link with the remote device remains established according to the second RAT, the superframe including at least two communication periods separated by at least one non-communication period;
suspending communications according to the second RAT during a communication period of the superframe; and
continuing communications according to the second RAT upon conclusion of the communication period, during a non-communication period of the at least one non-communication period.

11. The method of claim 10, further comprising:
determining that the wireless communication device is performing a high-priority operation according to the second RAT; and
in response to the determining, continuing communication according to the second RAT during a communication period of the superframe.

12. The method of claim 10, wherein a sum of durations of the communication periods of the superframe is not greater than a specified threshold value.

13. The method of claim 12, wherein the specified threshold value is dynamically configurable.

14. The method of claim 10, wherein each non-communication period of the superframe is longer, by at least a specified factor, than an immediately preceding communication period of the superframe.

15. The method of claim 10, wherein the suspending communications according to the second RAT is performed without notifying the remote device of the suspension.

16. The method of claim 10, further comprising:
connecting a shared antenna to a radio operating according to the first RAT during the communication periods; and
connecting the shared antenna to a radio operating according to the second RAT during the non-communication periods.

17. An apparatus for performing wireless communications, the apparatus comprising:
at least one memory storing software instructions; and
a processor configured to execute the software instructions, wherein executing the software instructions causes the apparatus to:
establish a communication link with a remote device according to a second RAT;
while the communication link remains established, receive an indication from a radio communicatively coupled to the apparatus that the radio is performing a communication period of a superframe according to a first RAT, wherein the superframe includes a plurality of communication periods that are separated by one or more intervening non-communication periods;
in response to receiving the indication, suspend communications according to the second RAT; and
resume communications according to the second RAT upon conclusion of the communication period.

18. The apparatus of claim 17, wherein executing the software instructions further causes the apparatus to:
determine that the apparatus is performing a high-priority operation according to the second RAT;
receive an indication from the radio that the radio is performing a second communication period of a superframe according to a first RAT; and
in response to the determining, continue communication according to the second RAT during the second communication period of the superframe.

19. The apparatus of claim 18, wherein executing the software instructions further causes the apparatus to:
provide an indication to the radio that the apparatus is performing the high-priority operation.

20. The apparatus of claim 17, wherein the suspending communications according to the second RAT is performed without notifying the remote device of the suspension.
